(19) United States
(12) Patent Application Publication
(10) Pub. No.: US 2010/0031046 A1
(43) Pub. Date: Feb. 4, 2010

(54) Method for Authorizing Access to at Least One Automation Component of a Technical System

(76) Inventor: Gerhard Heinemann, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/525,788

(22) PCT Filed: Feb. 1, 2008
(86) PCT No.: PCT/EP08/51246

§ 371 Date: Aug. 4, 2009

(30) Foreign Application Priority Data
Feb. 5, 2007 (DE) 10 2007 005 638.0

(51) Int. Cl. H04L 9/32

(52) U.S. Cl. 713/173; 713/176

(57) ABSTRACT

A method for authorizing access of different types to an automation component of a technical system and, if needed, logging and digitally signing them, is provided. An authorization unit, for example a smart card, holds a digital signature function and information of a user and allocated access rights. Optionally, the authorization unit also comprises a budget account for services for e.g. billing software services.

### CROSS REFERENCE TO RELATED APPLICATIONS

This application is the US National Stage of International Application No. PCT/EP2008/051246 filed Feb. 1, 2008 and claims the benefit thereof. The International Application claims the benefits of German Patent Application No. 10 2007 005 638.0 DE filed Feb. 5, 2007, both of the applications are incorporated by reference herein in their entirety.

### FIELD OF INVENTION

The invention relates to a method for authorizing access to at least one automation component of a technical system.

### BACKGROUND OF INVENTION

Modern technical systems generally comprise a plurality of so-called intelligent automation components, such as programmable controllers, field devices or drive controllers, for example, said automation components incorporating at least one processor and storage medium by means of which a desired automation solution can be executed by configuration and parameterization. Intelligent automation components of this kind are consequently flexible in their use and can be easily adapted to changing requirements corresponding to the changing requirements of the automation process.

Such work is generally carried out e.g. during commissioning by specially qualified personnel. The operations, settings and programming tasks involved are very sensitive, as they are crucially important for the proper, safe and efficient functioning of the entire technical system. In addition, secrecy aspects must be taken into account, as e.g. process engineering information or special recipes which are defined by the configuration, parameterization and programming must not be accessible to everyone.

Such work must therefore be carried out only by suitably trained and authorized personnel. This authorization can be multi-level and range from simple operator control tasks or adjustments through to in-depth interventions or inspections relating to the functioning of the system.

The ongoing maintenance of technical facilities is often assigned to third-party companies, an aspect where the checking of the authorization of the maintenance personnel is becoming an increasingly important consideration. In an age of increasing networking of system components by means of bus systems or an intranet or the Internet, the problem of authorization is assuming ever greater importance.

Moreover, the value of a technical system is increasingly determined by the functionality of the software used and not by the hardware components employed, which are often standardized and interchangeable.

System manufacturers therefore need to protect the automation components they have developed from unauthorized access to the developed software by means of suitable licensing and authorization methods.

In addition to the authorization of a user of the automation component, it is in many cases desirable or even mandatory to prepare a log detailing the actions carried out during a commissioning or maintenance procedure. This relates primarily to the food and pharmaceutical industry. Other reasons for logging of this kind can be the billing of services provided, the processing of warranty claims and the obtaining of statistical information about reliability, or else problem accumulation in the case of automated machines.

In order to check the authorization of an operator or of a service person to be authorized, mainly password-protected systems are currently used, the passwords either being hard coded into control software or freely selectable, and stored by the user. However, in both cases the problem arises that such passwords are unintentionally known to a comparatively large group of people and cannot therefore offer secure protection against unauthorized access. Particularly in cases of modifiable passwords, these would have to be documented at a suitable location, the documentation of said passwords constituting another source of problems in terms of unwanted divulgement of the passwords. In addition, the complexity in respect of maintaining in particular graduated access privileges is considerable here. Moreover, a password-enabled automation component is open for access by all connected communications partners, even though they may not possess the required qualification and authorization.

Another known possibility for protecting against unauthorized access is a mechanical barrier, e.g. by locking switch cabinet doors. However, modern systems may often be operated and maintained remotely, e.g. via a telephone line or the Internet, in which case mechanical protection of this kind is ineffective.

In the case of software licensing, there are currently likewise a number of solutions ranging from simple give-away software with vended hardware through to chargeable software functions. Particularly in the case of software, there is mainly the risk here of unchecked and illegal copying. In order to address this problem, so-called licensing codes are sometimes used which are calculated from complex licensing algorithms. For example, a customer can specify the serial number of the hardware on which a software package is to run, and then receives from the developer or manufacturer a license key with which he can activate the software on that hardware. However, licensing models of this kind are laborious to implement and a number of exception situations arise, e.g. if a defective hardware part with corresponding software must be changed and the old licensing code then no longer works.

Logging of parameterization, commissioning and maintenance operations, for example, is usually the responsibility of the personnel doing the work, e.g. by keeping plant log books in hardcopy or electronic form. Problems often arise here due to incomplete records. Sometimes logging also takes place automatically by an automation component itself, but this is totally detached from the person performing loggable actions on the system. Therefore, it cannot usually be established with certainty afterwards who has carried out particular actions.

### SUMMARY OF INVENTION

An object of the invention is therefore to specify an improved method for authorizing access to at least one automation component of a technical system.

For some partial aspects, solutions already exist, such as, for example, so-called smart cards which e.g. check an access authorization, enable cash to be withdrawn from ATMs, or can be used as a stored-value card or telephone card.

These smart cards contain an integrated circuit with microcontroller and a writable, nonvolatile memory. On the microcontroller, cryptographic algorithms can be executed which prevent unauthorized reading or modification of the data in the nonvolatile memory. In contrast to the hitherto commonly used magnetic stripe cards, these smart cards cannot be simply copied. Read/write devices can communicate with the smart cards via electronic contacts or, if suitably equipped (RFID), can also communicate wirelessly with the smart cards over short distances of a few centimeters. Near field communication of this kind is particularly convenient. The microcontrollers of these smart cards are mainly powerful enough to be able to calculate an asymmetrical encryption method using a public and a private key at least for a limited amount of data. This means that smart cards of this kind can also be used for verification and signature over nonsecure data links such as the Internet. As such smart cards can store a relatively large amount of information, and are protected against unauthorized copying, reading and modification of the stored information, this gives rise to their technical suitability in connection with the present invention. In particular, the authorization, licensing and logging of commissioning and maintenance actions in the case of automation components are to be improved. Only a single medium (the authorization unit/smart card) is required for all these tasks, while providing a high degree of flexibility for future upgrading.

The invention therefore results in a method for the authorization of access to at least one automation component of a technical system, comprising the following steps:
A) Providing an authorization unit, e.g. a smart card, containing
   a) a digital signature function;
   b) information about:
      (i) the identity of a user of the automation component,
      (ii) the automation components of the technical system to which the user is granted an access privilege,
      (iii) types of access privilege granted,
      (iv) a scope of validity of the access privilege granted for the automation components of the technical system in question or additionally for such automation components of other technical systems as correspond to the automation components of the technical system in question in terms of their type,
      (v) the user's technical knowledge level, e.g. technical training courses completed, and
      (vi) a period of validity of the access privilege granted;
B) Connecting the authorization unit to the automation component of the technical system; and
C) Performing technical actions on the automation component in accordance with the access privilege granted.

The invention is based on the consideration that, with the specified features, flexible, reliable and convenient authorization of access to the automation component is provided.

Said information and functions can be written to the smart card e.g. via appropriate write authorization codes both by the manufacturer of a technical system or automation component and by a system operator, an authorization unit advantageously also being able to contain a plurality of authorization keys for an individual person. These authorization keys can then be logically combined if e.g. a manufacturer authorizes a person for particular types of commissioning actions, as said person possesses appropriate knowledge. In addition, a system operator can authorize a person to access a number of technical systems of a particular type. These authorization keys mentioned by way of example can be stored on the same authorization unit, and the resulting detailed access privileges are derived from a logical combination of the individual privileges granted.

The connection of the authorization unit to the automation component advantageously takes place via an engineering system of the technical system, said system being designed to read and evaluate the authorization unit.

Complex technical systems comprise a large number of automation components and mostly contain an engineering system which is designed in particular to configure and parameterize all the automation components of the technical system. The engineering system is connected to the automation components e.g. via a bus system or an intranet or the Internet. Detection of the authorization unit can therefore take place centrally via the engineering system in order to access any automation components of the technical system.

In another advantageous embodiment of the invention, authorization to access the automation component is granted via the authorization unit in conjunction with an additional authorization/license server, at least some of the information contained in the authorization unit being storable and analyzable on the authorization/license server, i.e. the functionality of the authorization unit is distributed over the actual authorization unit (smart card) and the additional authorization/license servers.

Particularly in the case of internetworked authorization components which often have Internet capability, authorization via the authorization/license server specializing in performing authorization and licensing tasks is advantageous. For example, using the authorization/license server, a system operator can grant desired privileges to access particular automation components to individual persons identified by their respective authorization unit. This can be done online if the automation components and the authorization/license server are networked via the Internet. Here a system administrator can set up, block or adapt all access privileges from a central location at any time. Lost authorization units or deputization provisions are therefore no longer a problem. In addition, in the case of some in particular larger companies, the structures for integrating said authorization method are already in place, e.g. in the form of access authorization by means of smart card company ID cards. The same authorization unit that can authorize a parameterization, commissioning and maintenance action can also be used for a general operator control task which is subject to authorization if, for example, the automation component in question has a reading device for the authorization unit. In addition, the authorization unit can assume the access control function to the premises of the technical system.

For example, during commissioning or maintenance of a technical system the authorization unit is read in by the engineering system of the technical system, e.g. a notebook, which is equipped with a corresponding read/write device, thereby initially enabling access to any data records for the technical system that are already stored on the engineering system. Sensitive parameter and configuration files can be advantageously encrypted and decrypted via a crypto function on the authorization unit. In addition, the engineering system can undertake the forwarding of authorization unit information to the connected automation components in order to allow access to the automation components also. The access privileges can be graduated depending on the owner of the authorization unit.

Simpler, less complex automation components such as simple frequency converters, for example, are often put into service without an additional engineering system, e.g. simple numerical displays and some keys on the device itself being available for commissioning. Particularly in the case of less complex automation components of this kind, a possible solution is to incorporate an interface based on “near field communication” in order to establish a connection with the authorization unit from a distance of a few centimeters. A near field communication interface of this kind can then also be advantageously used for other commissioning sequences such as, for example, automation of the exchange of user pairings for installing Bluetooth and WLAN networks, automatic identification of order and serial numbers of components by means of RFID tags or making barcodes superfluous.

The authorization unit advantageously also includes a budget account by means of which payment can be made for automation component software functions to be activated, removed or modified.

For example, for installing software that is subject to license or enabling optional software functions that are subject to license on the authorization unit, license points can be stored in the budget account which are then debited by the software application in question. This then broadly corresponds to how a stored-value card works, the license points being able to be deposited in the budget account in various ways:
1. The authorization unit is loaded with license points directly by the manufacturer.
2. A system operator purchases from the manufacturer a number of license points and a corresponding access code for the authorization units; the system operator can then write to the authorization units himself using read/write devices.
3. A customer is connected to the manufacturer's license server via the Internet; he identifies himself there via his authorization unit and retrieves pre-purchased license points from said server which are stored on the authorization unit.

For software activation, for example, the authorization component then debits a corresponding points budget to the budget account of the authorization unit. Conversely, when software functions are deactivated, license points can also be recredited to the authorization unit in order, for example, to allow testing of a software installation. In addition, e.g. when replacing automation components, software-related license points can be transferred to new automation components.

Particularly advantageously, support services of the manufacturer on the automation component can be billed using the budget account of the authorization unit.

In another advantageous embodiment of the invention, the technical actions executed by the operator on the automation component include parametrizing and/or configuring and/or programming the automation component, which actions are logged and provided with a digital signature by means of the digital signature function.

It is advantageous here if the logging and signing takes place in a memory of the authorization unit or at least partly in an external memory.

The external memory can hold the log book data to be stored and can be provided in the automation component itself or in the engineering system.

A typical logging sequence as part of the commissioning of an automation component can look like this:
1. A commissioning engineer identifies himself using his authorization unit.
2. He changes the parameterization or configuration of the technical system.
3. Having made sure that the system is operating properly with the changed data, he issues, with the aid of the digital signature function of his authorization unit, his digital signature which is stored on the automation component together with the parameters which he has changed.
4. By means of a mathematical algorithm, a so-called GUID (Global Unique Identifier) is advantageously calculated on the automation component from the updated, changed parameters, a serial number of the automation component, a hardware and software version number, the commissioning engineer's digital signature and the current date.
5. Said GUID is stored on the automation component itself, on the authorization unit and on any associated engineering system. On the automation component and the engineering system, the GUID is concentrated together with the updated data, programs or parameters.

On the basis of the GUID, the data from which the latter was calculated can be uniquely identified. Any change to the underlying data results in a changed GUID. A list of the last GUIDs generated together with the respective creation date is advantageously stored on the automation component.

In addition, the GUID can be transmitted to an administration computer of the system operator by means of the authorization unit or the engineering system. The changed data, such as parameter values, for example, can then be stored on said administration computer.

By comparing the GUIDs stored in the automation component with the GUIDs stored on the administration computer, it can be verified, at any time, when and which changes have been made by which user.

In order to increase security against misuse of a person-related authorization unit, the latter can also be additionally provided with a personal identification number (PIN) or with the biometric data for identifying its owner.

### BRIEF DESCRIPTION OF THE DRAWINGS

Three exemplary embodiments of the invention will now be presented in greater detail.

In the accompanying drawings:

FIG. 1 shows an authorization method according to the invention using a smart card without license server,

FIG. 2 shows an authorization method according to the invention using a smart card and license server, and

FIG. 3 shows an authorization method according to the invention using a smart card without engineering system.

### DETAILED DESCRIPTION OF INVENTION

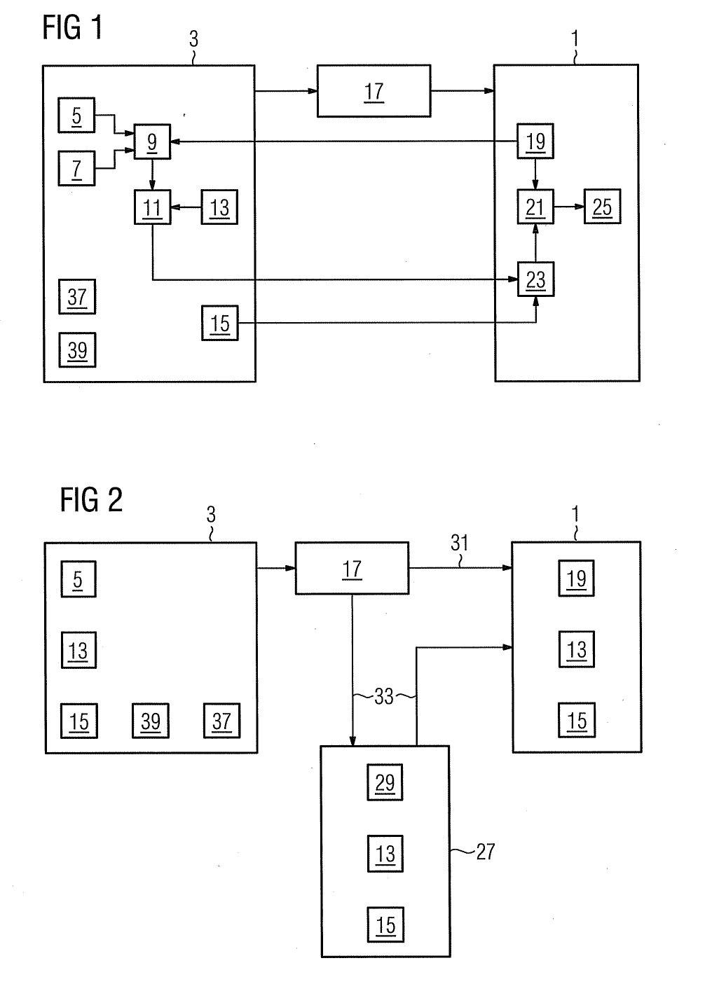

FIG. 1 shows an authorization method according to the invention, wherein data is read in from an authorization unit 3 implemented as a smart card by a read/write device of an engineering system 17 and forwarded to the automation component in order to enable the actions to be authorized on same. In order that the authorization can also be performed via an unsecure data line between engineering system and automation component, in this application encryption and decryption take place between authorization component and automation component. In this case, the engineering system together with its read/write device only constitutes a pass-through functionality for the encrypted data of the authorization unit and automation component, i.e. the connections between 3 and 1 shown outside 17 in FIG. 1 also pass through the unit 17. The authorization unit 3 contains a user's personal data 5 which allows at least the identity of the user or users of the authorization unit to be identified. The authorization unit 3 additionally contains a list of the access privileges 7 granted to the user on the authorization component 1 or on other automation components of a similar kind.

In addition, a selection function 9 is provided by means of which the currently required access privileges are selected from the access privileges granted. For this purpose the selection function 9 is connected by data link to the system identification data 19 of the automation component 1. The user can now perform actions on the automation component 1 optionally or as standard by means of an encryption unit 11 and his private key 13, in this case also providing a public key 15 for decrypting the data on the automation component 1.

The decryption of the transmitted data on the automation component 1 is undertaken by a decryption unit 23. To check the user's authorization, a verification unit 21 is provided which receives the decrypted transmitted data and the system identification data 19. In the event of a positive authorization check, an enable function 25 of the automation component 1 is triggered and the user's intended actions on the automation component 1 are approved. The user can initial the actions digitally by means of a digital signature function 37 and therefore attribute them unambiguously and bindingly to his person. A budget account 39 incorporated in authorization unit 3 contains license points in order to pay for any chargeable actions on the automation component 1, such as activating/unlocking a software function or service measure.

FIG. 2 corresponds essentially to FIG. 1 except that an authorization/license server 27 is present in addition to the engineering system 17 responsible for reading in, writing and forwarding the encrypted data on the authorization unit 3. The authorization/license server contains a database 29 containing the private 13 and public keys 15 of all users, as well as the associated access privileges. In this case it is therefore unnecessary for the access privileges to be stored directly on the authorization component itself.

For the authorization of such actions, an authorization connection 33 is provided which connects the engineering system, which reads the authorization unit, to the authorization/license server 27 and connects the latter to the authorization component 1.

In this embodiment, the connection of the authorization unit 3 to the automation component 1 takes place via the engineering system 17 which can be connected to a number of automation components. This means that the connection of the authorization unit 3 to a number of automation components 1 can be implemented centrally. The authorization/license server 27 specializes in checking, administering, billing and enabling the access privileges.

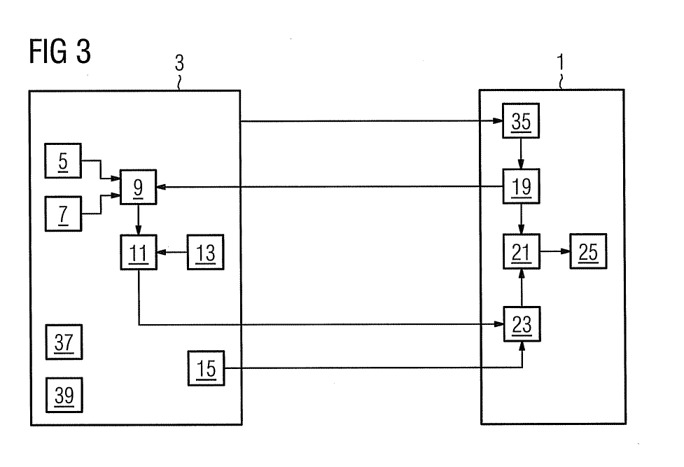

Lastly, FIG. 3 shows a corresponding method in which, however, no engineering system and no authorization/license server is provided. This is particularly advantageous in the case of less complex automation components such as simpler frequency converters. In order to establish a connection to the authorization unit 3, an RFID read/write unit is provided in order to establish a wireless connection to the authorization unit 3 over a distance of preferably a few centimeters (near field communication).

The different embodiments of the invention have the following elements in common, alternatively or in combination:
A person-related authorization unit (e.g. a smart card) is used for the authorization of, for example, commissioning and maintenance actions on the automation component, e.g. a drive controller or frequency converter.
Stored on the authorization unit is information identifying its owner and specifying which plants or components he/she can access in a particular period (digital ID function of the authorization unit).
Alternatively, this information can be stored on a central authorization/license server which is connected online to the automation components. In this case (see e.g. FIG. 2) the smart card is used for identification to the license server and the automation component.
A plurality of different access keys can be stored which are logically combinable in order to derive the resulting total access privileges from the individual access privileges.
Particularly in the case of drive controllers and frequency converters, asymmetrical encryption methods with public and private keys are used so that the authorization and encryption methods can also be handled via unsecure networks, e.g. for remote commissioning and diagnostics or maintenance.
Present on the authorization unit is a license points account e.g. for support services. Payment is taken from this budget account in the case of accesses e.g. via the intranet.
In addition to the parameter values and/or configuration information, a digital signature of the commissioning engineer, a serial number of the component and a creation date of the actions performed on the automation component are converted by an algorithm into a Global Unique Identifier (GUID), which preferably takes place on the automation component itself, thereby implementing a digital signature function of the authorization unit. The GUID is stored with the parameter values and/or configuration information both on the automation component and on a possibly present engineering system or a central administration computer for storing project information; this can be a central administration computer for storing project information. Thus virtually seamless logging of changes is implemented, and the integrity of the plant data can be verified.

1.-10. (canceled)

11. A method of authorizing access to an automation component of a technical system, comprising:
providing an authorization unit, containing
a digital signature function, and
information about:
an identity of a user of the automation component,
automation components of the technical system to which the user is granted an access privilege,
types of access privilege granted,
a scope of validity of the access privilege granted for the automation component of the technical system or additionally for such automation components of other technical systems, the automation components corresponding to the automation component of the technical system in terms of their type,
a technical knowledge level of the user, e.g. technical training courses completed, and
a period of validity of the access privilege granted;
connecting the authorization unit to the automation component of the technical system; and
performing technical actions on the automation component in accordance with the access privilege granted.

12. The method as claimed in claim 11, wherein the authorization unit is a smart card.

13. The method as claimed in claim 11, further comprising:
providing an engineering system, wherein the authorization unit is connected to the automation component via the engineering system, the engineering system being configured to read, write, evaluate and forward data of the authorization unit.

14. The method as claimed in claim 11, further comprising:
providing an authorization server, wherein the connecting of the authorization unit to the automation component involves the authorization server, wherein details relating to at least one element of the group {the user's identity, the automation components of the technical system to which the user is granted an access privilege, the types of access privilege granted, the scope of validity of the access privilege granted, the user's technical knowledge level and the validity period of the access privilege granted} are stored and evaluated on the authorization server.

15. The method as claimed in claim 13, further comprising:
providing an authorization server, wherein the connecting of the authorization unit to the automation component involves the authorization server, wherein details relating to at least one element of the group {the user's identity, the automation components of the technical system to which the user is granted an access privilege, the types of access privilege granted, the scope of validity of the access privilege granted, the user's technical knowledge level and the validity period of the access privilege granted} are stored and evaluated on the authorization server.

16. The method as claimed in claim 11, wherein the technical actions include parameterization and/or configuring and/or programming of the automation component which are logged and provided with a digital signature of the digital signature function.

17. The method as claimed in claim 16, wherein the logging and signing takes place in a memory of the authorization unit or at least partly in an external memory.

18. The method as claimed in claim 16, further comprising:
determining a Global Unique Identifier (GUID) by a mathematical algorithm based at least on the technical actions performed, identification data of the automation component, the digital signature and a current date.

19. The method as claimed in claim 17, further comprising:
determining a Global Unique Identifier (GUID) by a mathematical algorithm based at least on the technical actions performed, identification data of the automation component, the digital signature and a current date.

20. The method as claimed in claim 18, wherein the Global Unique Identifier is calculated on the automation component and stored together with parameter, programming or configuration data.

21. The method as claimed in claim 19, wherein the Global Unique Identifier is calculated on the automation component and stored together with parameter, programming or configuration data.

22. The method as claimed in claim 11, wherein the authorization unit includes a budget account for making payments for software functions of the automation component that are to be activated, removed or modified.

23. The method as claimed in claim 11, wherein the authorization unit incorporates an encryption function allowing encrypted data transmission to and from the authorization unit.

24. The method as claimed in claim 23, wherein the encryption function is set up for an encrypted storing of data on the engineering system or a data carrier, so that the stored data can only be accessed by authorized users.

25. A technical system, comprising:
an authorization unit including a digital signature function and information about:
an identity of a user of the automation component,
automation components of the technical system to which the user is granted an access privilege,
types of access privilege granted,
a scope of validity of the access privilege granted for the automation component of the technical system or additionally for such automation components of other technical systems, the automation components corresponding to the automation component of the technical system in terms of their type,
a technical knowledge level of the user, e.g. technical training courses completed, and
a period of validity of the access privilege granted;
an automation component, the authorization unit being connected to the automation component and technical actions being performed on the automation component;
an engineering system, the authorization unit being connected to the automation component via the engineering system, the engineering system being configured to read, write, evaluate and forward data of the authorization unit; and
an authorization server, wherein the connecting of the authorization unit to the automation component involves the authorization server, wherein details relating to at least one element of the group {the user's identity, the automation components of the technical system to which the user is granted an access privilege, the types of access privilege granted, the scope of validity of the access privilege granted, the user's technical knowledge level and the validity period of the access privilege granted} are stored and evaluated on the authorization server.

26. The technical system as claimed in claim 25, wherein the authorization unit is a smart card.

27. The technical system as claimed in claim 25, wherein the technical actions include parameterization and/or configuring and/or programming of the automation component which are logged and provided with a digital signature of the digital signature function.

28. The technical system as claimed in claim 27, wherein the logging and signing takes place in a memory of the authorization unit or at least partly in an external memory.

29. The technical system as claimed in claim 27, wherein a Global Unique Identifier (GUID) is determined by a mathematical algorithm based at least on the technical actions performed, identification data of the automation component, the digital signature and a current date.

30. The technical system as claimed in claim 29, wherein the Global Unique Identifier is calculated on the automation component and stored together with parameter, programming or configuration data.
